(19) United States
(12) Patent Application Publication
(10) Pub. No.: US 2021/0344071 A1
(43) Pub. Date: Nov. 4, 2021

(54) ELECTRIC BATTERY

(71) Applicant: Mahle International GmbH, Stuttgart (DE)

(72) Inventors: Julius Aktas, Bietigheim-Bissingen (DE); Peter Geskes, Ostfildern (DE); Johannes Weinmann, Stuttgart (DE)

(21) Appl. No.: 17/243,554

(22) Filed: Apr. 28, 2021

(30) Foreign Application Priority Data
Apr. 29, 2020 (DE) 102020205423.1

(51) Int. Cl. H01M 50/209; H01M 10/613; H01M 10/625; H01M 10/6556; H01M 50/505

(52) U.S. Cl. CPC H01M 50/209; H01M 10/613; H01M 2220/20; H01M 10/6556; H01M 50/505; H01M 10/625

(57) ABSTRACT

An electric battery for, e.g., a motor vehicle, is disclosed. The electric battery includes a base, at least two battery cell modules arranged on the base at a cell spacing to one another, and at least two housing parts secured to the base and each defining, together with the base, a respective interior housing space. The interior housing spaces accommodate at least one of the battery cell modules. The at least two battery cell modules arranged in the interior space adjacent to one another are electrically connected to one another via an electrical connecting line passing through an intermediate space between the at least two battery cell modules.

### CROSS-REFERENCE TO RELATED APPLICATION

This application claims priority to Germany Application No. DE 10 2020 205 423.1 filed on Apr. 29, 2020, the contents of which are hereby incorporated by reference in its entirety.

### TECHNICAL FIELD

The invention relates to an electric battery, in particular for a motor vehicle.

### BACKGROUND

For some time, electric batteries which comprise multiple battery cells have been used for storing electrical energy. Such batteries are used in particular in battery-powered electric motor vehicles for storing and providing electrical energy or power for an electric drivetrain. To increase the electrical storage capacity of the electric battery and/or to establish an electrical rated voltage, it is necessary to connect the individual battery cells electrically to one another. Usually, the battery cells of the electric battery are arranged on a common base, which may be formed as a cooling plate for the cooling of the electric battery. Furthermore, this base on which the battery cells of the electric battery are arranged provides adequate mechanical stability for the electric battery. Usually fastened on the base for this purpose is a housing part formed in the manner of a pot, which together with the base of the electric battery delimits an interior housing space. All of the battery cells of the electric battery arranged on the base are in this case arranged within this interior housing space. This means that, in the case of conventional electric batteries, the battery cells of the electric battery are enclosed together in a single interior housing space by means of a single housing part. In the case of such conventional arrangements, the electrical connecting lines between the battery cells of the electric battery located in the interior housing space are likewise arranged in the interior housing space and are thus protected from external influences by means of the housing part.

However, such a housing part that is used in the case of conventional electric batteries and covers all of the battery cells of the electric battery is necessarily very bulky. Such bulky housing parts can typically only be produced with difficulty with the required production tolerances and what is more only have inadequate internal pressure resistance with respect to an internal pressure prevailing in the interior housing space.

It is therefore an object of the present invention to present new approaches with respect to electric batteries—in particular for eliminating the aforementioned disadvantages.

This object is achieved by a battery according to the independent Patent Claim(s). Preferred embodiments are the subject of the dependent patent claims.

### SUMMARY

The basic concept of the invention is accordingly to arrange on a housing base of an electric battery—referred to hereinafter as the “base”—a number of housing parts, each of which together with the base delimits a separate interior housing space. Each one of the interior housing spaces in this case accommodates at least one of two battery cell modules, with in each case a number of battery cells of the electric battery. Between the battery cell modules there is an intermediate space, which is passed through by an electrical connecting line, thereby providing electrical connection of the battery cell modules arranged in two interior housing spaces adjacent to one another.

This provides the advantage that the housing parts are much less bulky than is the case with a conventional electric battery, which improves the producibility of the housing parts. Furthermore, the multiple housing parts are impressive in their increased internal pressure resistance.

An electric battery according to the invention, which can preferably be used for a motor vehicle, has a base with a baseplate. In this case, the baseplate is preferably formed as a cooling plate for cooling the battery. Such a base formed as a cooling plate may comprise a material with good thermal conductivity. Such a base formed as a cooling plate may also comprise cooling channels through which a coolant can flow, by means of which coolant heat produced during operation of the electric battery can be removed. The electric battery also comprises at least two battery cell modules with in each case a number of battery cells, the battery cell modules being arranged on the base at a cell spacing from one another, so that an intermediate space is formed between the at least two battery cell modules. In addition, the electric battery has at least two housing parts, which are fastened on the base. Each of the housing parts delimits together with the base a separate interior housing space. Each of the interior housing spaces accommodates at least one of the battery cell modules. At least two battery cell modules arranged in interior housing spaces adjacent to one another are electrically connected to one another by means of an electrical connecting line, the invention providing that the electrical connecting line passes through the intermediate space between the battery cell modules. Thus, housing parts of a small size can be advantageously used for enclosing the battery cell modules, which offer advantages with respect to their producibility. Furthermore, such multiple housing parts can be formed with greater internal pressure resistance.

According to an advantageous development of the electric battery, the base comprises a carrier, which is preferably formed in a hollow-profiled manner—that is to say as a hollow profile. The carrier is arranged in the intermediate space between the two battery cell modules on the baseplate of the base. A feed-through is arranged in the carrier. The electrical connecting line passes through the feed-through of the carrier, thereby providing electrical connection of the battery cell modules. By means of such a carrier, mechanical stiffness of the base, and consequently also of the electric battery as a whole, is advantageously improved.

In the case of a further preferred development of the electric battery, the feed-through accommodates a feed-through profile. The feed-through profile delimits an internal profile space and preferably closes off carrier sides of the carrier opposite one another and respectively facing one of the battery cell modules at both ends substantially flush with one another. In this case, the electrical connecting line passes through the interior profile space of the feed-through profile and protrudes at both ends into a respective one of the interior housing spaces for the electrical connection of the battery cell modules. It is advantageously possible in this way to dispense with a cutout that weakens the housing parts for feeding through the electrical connecting line.

The electrical connecting line expediently comprises a high-voltage cable. Such high-voltage cables can be bought inexpensively, with accompanying cost advantages in the production of the electric battery.

A further preferred development of the electric battery provides that the electrical connecting line comprises a busbar with two busbar end elements and a busbar bridge element. Each one of the busbar end elements has in this case an electrical terminal for electrically connecting one battery cell module in each case. On one of the housing parts in each case there is a cutout. As an alternative or in addition to the cutout, the housing parts have in each case an aperture. By way of the cutout or the aperture in the housing parts, the interior housing space of the respective housing part is connected to an outer surrounding area that surrounds the electric battery on the outside. The busbar end elements have in each case a pass-through portion, by means of which the busbar end elements each pass through one of the cutouts or apertures. The busbar end elements are electrically connected to one another by means of the busbar bridge element in the intermediate space at their pass-through portions. This advantageously offers a possibility of realizing the electrical connecting line that can be implemented particularly easily.

According to a further preferred development of the electric battery, the busbar of the electrical connecting line has an elastically deformable buffer portion to compensate for thermal expansion and/or tolerance. The buffer portion is expediently present on at least one of the busbar end elements and/or on the busbar bridge element. The elastically deformable buffer portion advantageously makes it possible that the busbar of the electrical connecting line can be produced with great production tolerances, which has positive effects on the production costs of the busbar. Furthermore, mechanical stresses that form because of different thermal expansions of the components of the electric battery can be effectively reduced by means of the buffer portion.

According to a further advantageous development of the electric battery, the busbar of the electrical connecting line has an injection-moulded encapsulation, preferably of plastic. The injection-moulded encapsulation is in this case particularly preferably arranged in the region of the busbar bridge element of the busbar. By means of the injection-moulded encapsulation, the cutouts or the apertures in the housing parts are closed fluid-tightly. A pressure-tight form of the housing parts is in this way advantageously achieved particularly easily.

A further advantageous development of the electric battery provides that the busbar is formed as one part, so that the busbar of the electrical connecting line comprises the busbar end elements and the busbar bridge element in one and the same material. This development is impressive in its low number of parts, which has advantageous effects on the amount of effort involved in assembly and consequently on the production costs of the electric battery.

In the case of a further preferred development of the electric battery, the busbar of the electrical connecting line is formed as at least three parts. In this case, the busbar bridge element and the busbar end elements each form a physically separate component. Such a form of the busbar offers the advantage that an electrical connection between the electric battery cell modules can be broken by means of disassembling the components of the busbar, without one of the housing parts having to be disassembled from the base. This offers advantages, in particular in the servicing of the electric battery.

According to a further advantageous development of the electric battery, the components of the busbar are in each case connected to one another by a screw connection or a clamp connection, thereby forming the busbar. Such a screw or clamp connection offers a particularly good possibility for connecting the components of the busbar to one another, in particular releasably.

The cutouts or apertures in the housing parts are expediently cut out along a joining direction in which the housing parts are assembled or can be assembled on the base.

According to a further preferred development of the electric battery, a sealing element is present at the cutout or the aperture in at least one of the housing parts. By means of the sealing element, the interior housing space of the housing part concerned is closed fluid-tightly, with the busbar passing through the cutout or the aperture. Such a sealing element has advantageous effects on a seal-tightness of the housing part.

A further advantageous development of the electric battery provides that the busbar extends from a first of the electrical terminals to a second of the electrical terminals along a busbar direction. In this case, the sealing element completely surrounds the busbar in a section perpendicular to the direction of the bar. This makes possible particularly good sealing of the respective interior housing space that is delimited by the housing part in which the sealing element is arranged.

In the case of a further advantageous development of the electric battery, a housing seal is present between at least one of the housing parts and the base. Such a housing seal likewise has advantageous effects on a seal-tightness of the respective housing part and at the same time makes it possible to compensate for certain production tolerances of the baseplate or of the housing part concerned.

The interior housing spaces are expediently delimited in each case fluid-tightly, in particular tightly with respect to internal pressure. Consequently, a temperature-control fluid may be advantageously provided in the interior housing spaces or flow through the interior housing spaces in order to control the temperature of the battery cell modules.

Further important features and advantages of the invention can be found in the subclaims, the drawings and the associated description of the figures on the basis of the drawings.

It goes without saying that the features mentioned above and those still to be explained below can be used not only in the respectively specified combination but also in other combinations or on their own without departing from the scope of the present invention.

Preferred exemplary embodiments of the invention are shown in the drawings and are explained in greater detail in the following description, with identical designations relating to identical or similar or functionally identical components.

### BRIEF DESCRIPTION OF THE DRAWINGS

In the drawings, in each case schematically

FIG. 1 shows an example of an electric battery according to the invention in a perspective representation,

FIG. 2 shows a further example of an electric battery according to the invention in a detail of a perspective broken-open representation,

FIG. 3 shows the example of FIG. 2 in a sectional representation,

FIG. 4 shows a further example of an electric battery according to the invention in a detail of a perspective representation,

FIG. 5 shows the example of FIG. 4 in a section,

FIG. 6 shows a further example of an electric battery according to the invention in a detail of a perspective representation,

FIG. 7 shows the example of FIG. 6 in a detail of a perspective broken-open representation,

FIG. 8 shows the example of FIGS. 6 and 7 in a further perspective broken-open representation of a detail,

FIG. 9 shows a further example of an electric battery according to the invention in a perspective representation of a detail,

FIG. 10 shows the example of FIG. 9 in a sectional representation.

### DETAILED DESCRIPTION

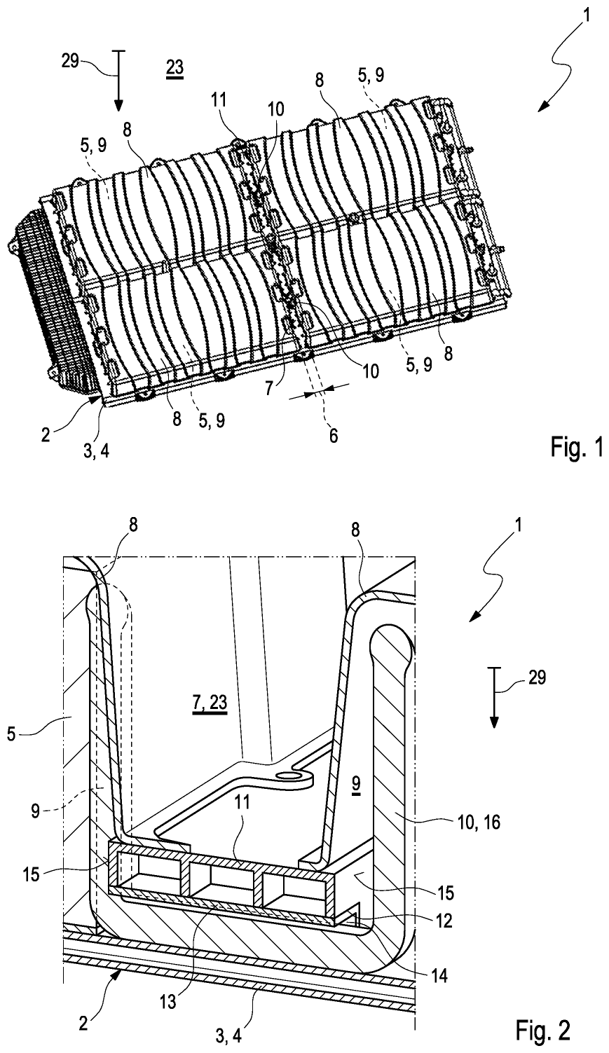

In FIG. 1, an example of a battery 1 according to the invention is shown in a perspective representation. The electric battery 1 is intended for use in a motor vehicle. In particular, it can store electrical energy for driving an electric drive present in the motor vehicle. The electric battery 1 has a (housing) base 2. The base 2 in turn comprises a baseplate 3. In the example shown, the baseplate 3 is formed as a cooling plate 4. The electric battery 1 also comprises at least two battery cell modules 5. Each battery cell module 5 may comprise multiple battery cells. In the example shown, there are four such battery cell modules 5. The battery cell modules 5 are arranged on the base 2 at a cell spacing 6 from one another. In this case, the at least two battery cell modules 5 are arranged on the base 2 at the cell spacing 6 from one another in such a way that an intermediate space 7 is formed between the at least two battery cell modules 5. The electric battery 1 comprises at least two housing parts 8, which are fastened on the base 2. In the example shown, there are four such housing parts 8. Each of the housing parts 8 delimits together with the base 2 a separate interior housing space 9. Each of the interior housing spaces 9 accommodates at least one of the battery cell modules 5. In the example shown, each of the interior housing spaces 9 accommodates exactly one such battery cell module 5. It can also be seen that two battery cell modules 5, arranged in interior housing spaces 9 adjacent to one another, are electrically connected to one another by means of an electrical connecting line 10. This electrical connecting line 10 in this case passes through the intermediate space 7 between these battery cell modules 5, thereby providing electrical connection of the battery cell modules 5 arranged in the interior housing spaces 9 adjacent to one another. The interior housing spaces 9 are for example delimited in each case fluid-tightly, in particular tightly with respect to internal pressure.

In FIG. 2, a further example of an electric battery 1 according to the invention is shown in a detail of a perspective broken-open representation. It can be seen that the base 2 comprises a carrier 11, which is arranged in the intermediate space 7 between the two battery cell modules 5 on the baseplate 3 of the base 2. In the example shown, the carrier 11 is hollow-profiled, which means that the carrier 11 is formed as a hollow profile. Arranged in the carrier 11 is an electrical feed-through 12, which the electrical connecting line 10 passes through, thereby providing electrical connection of the battery cell modules 5.

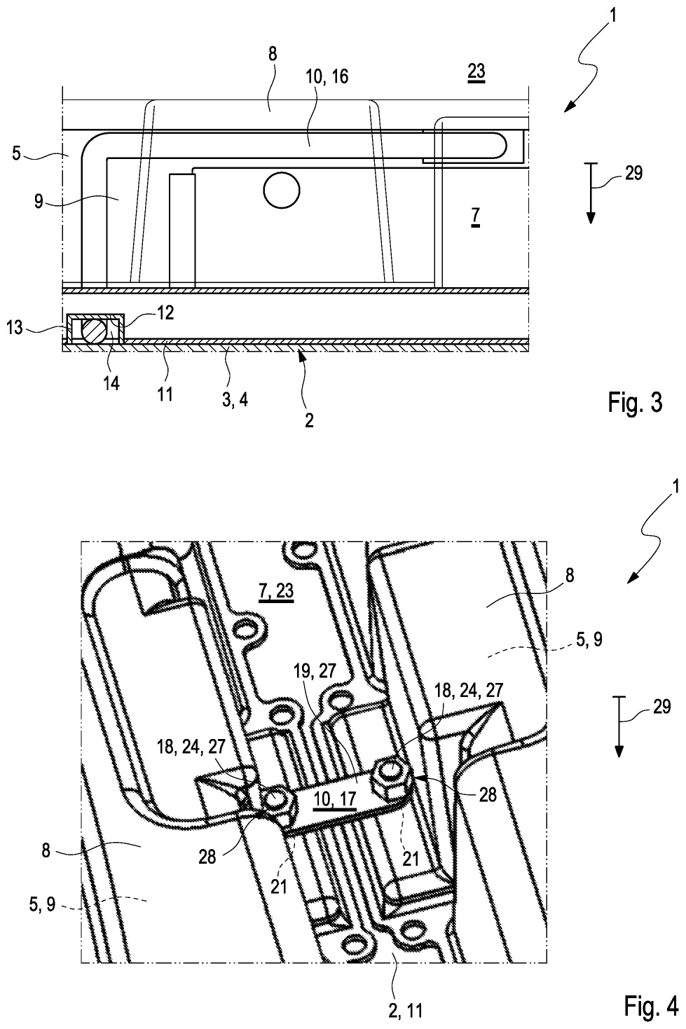

In FIG. 3, the example of FIG. 2 is shown in a section through the intermediate space 7. It can be seen that the electric battery 1 has a feed-through profile 13, which is accommodated in the feed-through 12 of the carrier 11. The feed-through profile 13 delimits an interior profile space 14. In the example shown (cf. in particular FIG. 2), the feed-through profile 13 closes off carrier sides 15 opposite one another and respectively facing one of the battery cell modules 5 at both ends substantially flush with one another. In this case, the electrical connecting line 10 passes through the interior profile space 14, so that the electrical connecting line 10 protrudes at both ends into a respective one of the separate interior housing spaces 9 for the electrical connection of the battery cell modules 5. In the example of FIGS. 2 and 3, the electrical connecting line 10 comprises a high-voltage cable 16.

FIG. 4 illustrates in a detail of a perspective representation a further example of an electric battery 1 according to the invention, in which the electrical connecting line 10 does not comprise a high-voltage cable as in the example of FIGS. 2 and 3, but a busbar 17. The busbar 17 has two busbar end elements 18 and a busbar bridge element 19.

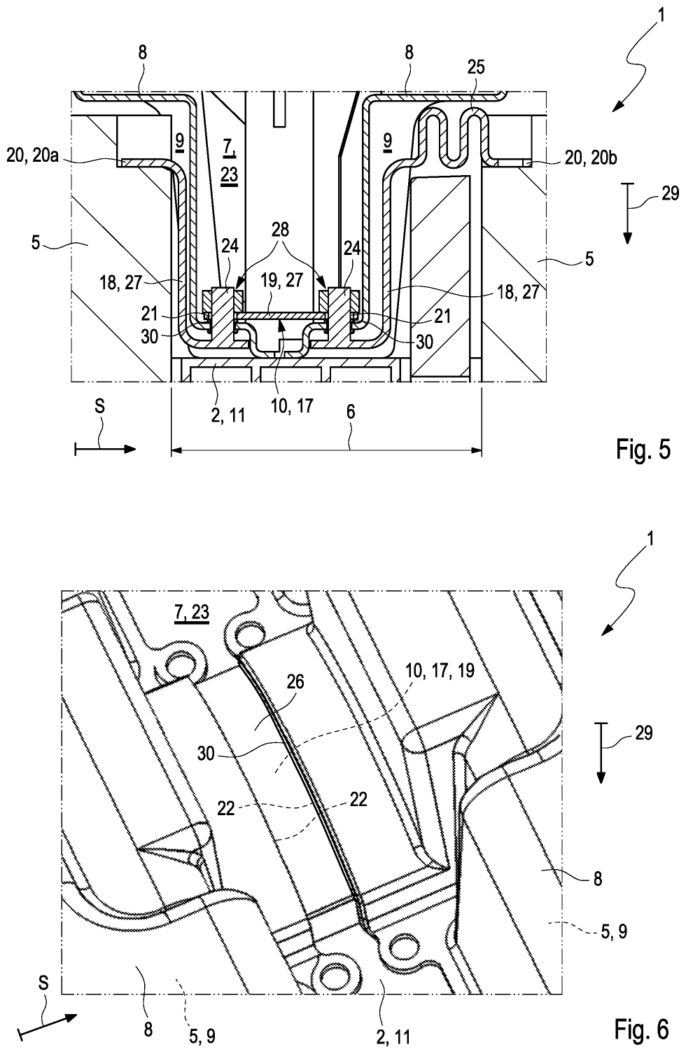

In FIG. 5, the example of FIG. 4 is shown in section. It can be seen that each one of the busbar end elements 18 of the electrical connecting line 10 comprising the busbar 17 has an electrical terminal 20 for electrically connecting one battery cell module 5 in each case. It is also shown that in each of the housing parts 8 there is an aperture 21, by way of which the interior housing space 9 of the respective housing part 8 is connected to an outer surrounding area 23 that surrounds the electric battery 1 on the outside. The busbar end elements 18 have in each case a pass-through portion 24, which passes through a respective one of the apertures 21. The busbar end elements 18 are in this case electrically connected to one another by means of the busbar bridge element 19 in the intermediate space 7 at their pass-through portions 24. In a way corresponding to the example shown in FIGS. 4 and 5, the busbar bridge element 19 may in this case be arranged in the outer surrounding area 23 in the intermediate space 7. The busbar end elements 18 may be pretensioned against the aperture 21 in the respective housing part 8 in the region of their passthrough portions 24 by means of a pretensioning device that is not shown for reasons of overall clarity. The busbar 17 of the electrical connecting line 10 has an elastically deformable buffer portion 25 to compensate for thermal expansion and/or tolerance. The buffer portion 25 may be formed in the manner of a leaf spring.

In FIG. 6, a further example of an electric battery 1 according to the invention is shown in a detail of a perspective representation. In a way corresponding to this example, the busbar 17 of the electrical connecting line 10 comprises an injection-moulded encapsulation 26. The injection-moulded encapsulation 26 is arranged in the region of the busbar bridge element 19. The injection-moulded encapsulation 26 comprises a plastic. As an alternative to the example of FIGS. 4 and 5, instead of the apertures 21, the housing parts 8 each have according to the example of FIG. 6 a cutout 22, by way of which the interior housing space 9 of the respective housing part 8 is connected to the outer surrounding area 23 that surrounds the electric battery 1 on the outside. These cutouts 22 in the housing part 8 are closed fluid-tightly by means of the injection-moulded encapsulation 26. The cutouts 22 or apertures 21 of the housing parts 8 are cut out along a joining direction 29 in which the housing parts 8 are assembled or can be assembled on the base 2.

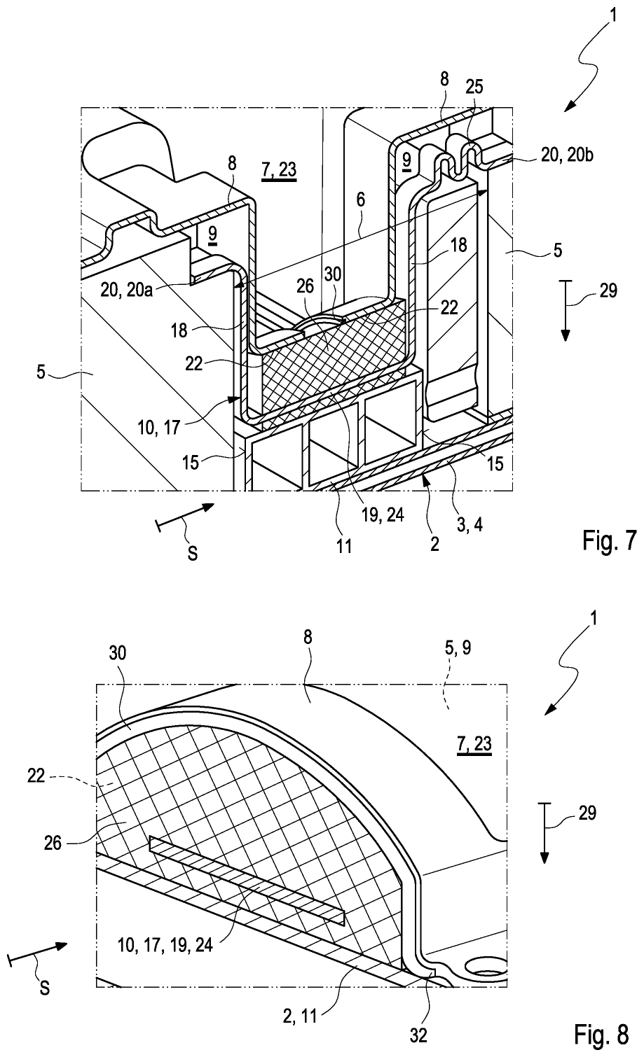

In FIG. 7, the example of FIG. 6 is shown in a detail of a perspective broken-open representation. It can be seen that the busbar 17 of the electrical connecting line 10 is formed as one part and comprises the busbar end elements 18 and the busbar bridge element 19 in one and the same material.

By contrast with this, the busbar 17 according to the example of FIGS. 4 and 5 is formed as at least three parts, the busbar bridge element 19 and the busbar end elements 18 each forming physically separate components 27 of the busbar 17. In this case, the components 27 of the busbar 17 are in each case connected to one another by a screw connection 28, thereby forming the busbar 17. As an alternative to the illustrated screw connection 28, a clamp connection may be used for connecting the components 27 of the busbar 17.

In FIG. 8, the example of FIGS. 6 and 7 is shown in a detail of a further broken-open representation. It can be seen that a sealing element 30 is present at the cutout 22 in at least one of the housing parts 8 and by means of the sealing element the interior housing space 9 of the housing part 8 concerned is closed fluid-tightly, with the busbar 17 passing through the cutout 22. It can also be seen that a housing seal 32 is indicated as present between at least one of the housing parts 8 of the electric battery 1 and the base 2.

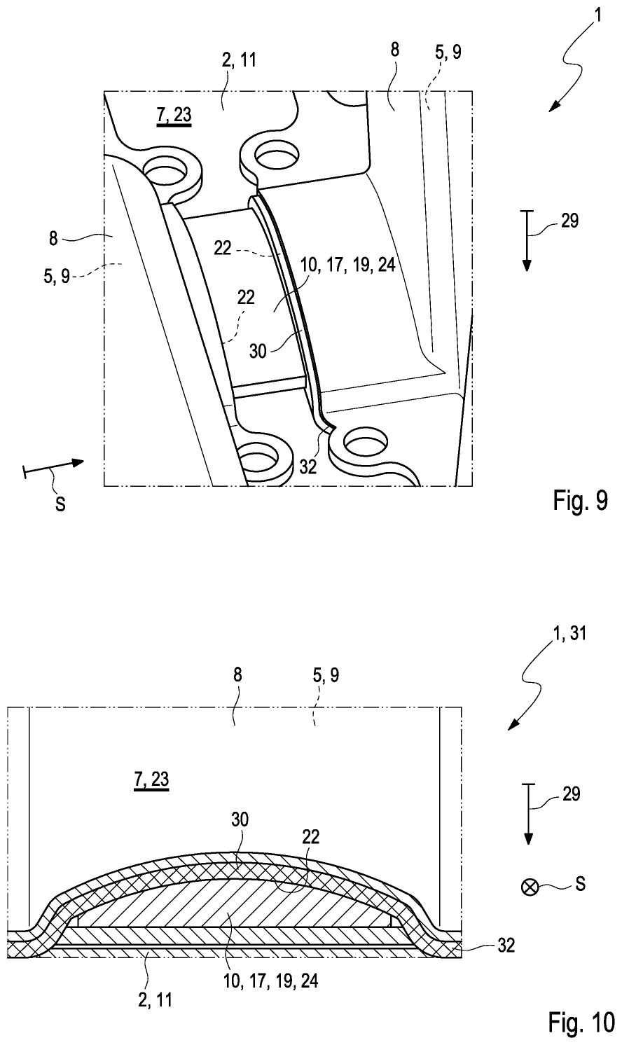

A further example of a battery 1 according to the invention is shown in a perspective partial representation in FIG. 9. FIG. 10 shows the example of FIG. 9 in a section 31 through the intermediate space 7. The section 31 in this case extends perpendicularly to a busbar direction S, along which the busbar 17 extends from a first of the electrical terminals 20, 20a to a second of the electrical terminals 20, 20b. According to FIG. 10, the sealing element 30 completely surrounds the busbar 17 in the section 31 perpendicular to the busbar direction S.

1. An electric battery, comprising:
a base including a baseplate,
at least two battery cell modules that are arranged on the base at a cell spacing from one another, such that an intermediate space is provided between the at least two battery cell modules,
at least two housing parts that are secured on the base, each of the at least two housing parts together with the base defining a respective interior housing space,
each of the interior housing spaces accommodating at least one of the at least two battery cell modules, and
the at least two battery cell modules arranged in the interior housing spaces adjacent to one another being electrically connected to one another via an electrical connecting line passing through the intermediate space.

2. The electric battery according to claim 1, wherein the base further includes a carrier that is arranged in the intermediate space between the at least two battery cell modules on the baseplate of the base.

3. The electric battery according to claim 2, further comprising a feed-through arranged in the carrier, wherein the electrical connecting line passes through the feed-through to provide the electrical connection of the at least two battery cell modules.

4. The electric battery according to claim 3, wherein:
the feed-through accommodates a feed-through profile that delimits an interior profile space and closes off carrier sides of the carrier opposite to one another and respectively facing one of the at least two battery cell modules at both ends substantially flush with one another, and
the electrical connecting line passing through the interior profile space and protruding at both ends into a respective one of the interior housing spaces for the electrical connection of the at least two battery cell modules.

5. The electric battery according to claim 1, wherein the electrical connecting line comprises a high-voltage cable.

6. The electric battery according to claim 1, wherein:
the electrical connecting line comprises a busbar with two busbar end elements and a busbar bridge element,
each one of the two busbar end elements has an electrical terminal for electrically connecting a respective one of the at least two battery cell modules,
on each one of the at least two housing parts there is at least one of a cutout and an aperture that connects the interior housing space of the respective one of the at least two housing parts to an outer surrounding area,
the two busbar end elements in each case passing through the at least one of the cutout and aperture with a respective pass-through portion of the two busbar end element, and
the two busbar end elements being electrically connected to one another via the busbar bridge element in the intermediate space at the respective pass-through portion.

7. The electric battery according to claim 6, wherein the busbar has an elastically deformable buffer portion to compensate for at least one of thermal expansion and tolerance.

8. The electric battery according to claim 6, wherein the busbar has an injection-moulded encapsulation that closes the at least one of the cutout and the aperture in the at least two housing parts fluid-tightly.

9. The electric battery according to claim 6, wherein the busbar is formed as one part and comprises the two busbar end elements and the busbar bridge element in the same material.

10. The electric battery according to claim 6, wherein:
the busbar is structured as at least three parts, and
the busbar bridge element and the two busbar end elements each define a physically separate component.

11. The electric battery according to claim 10, wherein the at least two parts of the busbar are in each case connected to one another via a screw connection or a clamp connection to form the busbar.

12. The electric battery according to claim 6, wherein the at least one of the cutout and the aperture in the at least two housing parts are cut out along a joining direction in which the at least two housing parts are assembled.

13. The electric battery according to claim 6, further comprising a sealing element provided at the at least one of the cutout and the aperture in at least one of the at least two housing parts, wherein the interior housing space of the at least one housing part is closed fluid-tightly via the sealing element, with the busbar passing through the at least one of the cutout and the aperture.

14. The electric battery according to claim 13, wherein:
the busbar extends from a first of the electrical terminals to a second of the electrical terminals along a busbar direction, and
the sealing element completely surrounds the busbar in a section perpendicular to the busbar direction.

15. The electric battery according to claim 1, further comprising a housing seal provided between at least one of the two housing parts and the base.

16. The electric battery according to claim 1, wherein the interior housing spaces are delimited in each case fluid-tightly.

17. The electric battery according to claim 1, wherein the baseplate of the base is a cooling plate.

18. A motor vehicle, comprising: an electric battery, the electric battery including:
a base including a baseplate;
at least two battery cell modules arranged on the base at a cell spacing from one another, such that an intermediate space is provided between the at least two battery cell modules;
at least two housing parts secured on the base, each of the at least two housing parts together with the base defining a respective interior housing space;
each of the interior housing spaces accommodating at least one of the at least two battery cell modules; and
the at least two battery cell modules arranged in the interior housing spaces adjacent to one another being electrically connected to one another via an electrical connecting line passing through the intermediate space.

19. The motor vehicle according to claim 18, wherein the base further includes a hollow-profiled carrier that is arranged in the intermediate space between the at least two battery cell modules on the baseplate.

20. The motor vehicle according to claim 18, wherein:
the electrical connecting line comprises a busbar with two busbar end elements and a busbar bridge element;
each one of the two busbar end elements has an electrical terminal for electrically connecting a respective one of the at least two battery cell modules;
on each one of the at least two housing parts there is at least one of a cutout and an aperture that connects the interior housing space of the respective one of the at least two housing parts to an outer surrounding area;
the two busbar end elements in each case passing through the at least one of the cutout and aperture with a respective pass-through portion of the two busbar end element; and
the two busbar end elements being electrically connected to one another via the busbar bridge element in the intermediate space at the respective pass-through portion.
